(19) United States
(12) Patent Application Publication
(10) Pub. No.: US 2026/0044576 A1
(43) Pub. Date: Feb. 12, 2026

(54) INFORMATION RECOMMENDATION METHOD AND APPARATUS, ELECTRONIC DEVICE, COMPUTER-READABLE STORAGE MEDIUM, AND COMPUTER PROGRAM PRODUCT

(71) Applicant: BEIJING SOGOU TECHNOLOGY DEVELOPMENT CO., LTD., Beijing (CN)

(72) Inventors: Xiaofeng GAO, Beijing (CN); Junwei PAN, Beijing (CN); Shudong HUANG, Beijing (CN); Dapeng LIU, Beijing (CN); Lei XIAO, Beijing (CN); Jie JIANG, Beijing (CN); Xinyi ZHOU, Beijing (CN); Yiming LIU, Beijing (CN)

(73) Assignee: BEIJING SOGOU TECHNOLOGY DEVELOPMENT CO., LTD., Beijing (CN)

(21) Appl. No.: 19/360,262

(22) Filed: Oct. 16, 2025

Related U.S. Application Data
(63) Continuation of application No. PCT/CN2024/111756, filed on Aug. 13, 2024.

(30) Foreign Application Priority Data
Oct. 11, 2023 (CN) 202311315390.7

(51) Int. Cl. G06F 18/2113; G06F 18/2137; G06N 3/063

(52) U.S. Cl. CPC G06F 18/2113; G06F 18/2137; G06N 3/063

(57) ABSTRACT

An information recommendation method, apparatus, electronic device, computer-readable storage medium, and a computer program product are provided. The method includes: obtaining a plurality of field features of a to-be-recommended task, the plurality of field features including at least one item feature of to-be-recommended information and at least one object feature of a target object; performing layer construction on the plurality of field features by using each layer constructor of a multi-layer constructor, to obtain cross features of each layer constructor; performing weighted aggregation on cross features corresponding to the multi-layer constructor, to obtain an aggregated feature of the to-be-recommended task; performing metric prediction on the aggregated feature, to obtain a recommendation metric that corresponds to the target object and that is of the to-be-recommended information; and performing a recommendation based on the recommendation metric that corresponds to the target object and that is of the to-be-recommended information.

### RELATED APPLICATION

This application is a continuation application of PCT Patent Application No. PCT/CN2024/111756, filed on Aug. 13, 2024, which claims priority to Chinese Patent Application No. 202311315390.7, filed on Oct. 11, 2023, each of which is incorporated by reference in its entirety.

### FIELD OF THE TECHNOLOGY

This application relates to artificial intelligence technologies, and in particular, to an information recommendation method and apparatus, an electronic device, a computer-readable storage medium, and a computer program product.

### BACKGROUND OF THE DISCLOSURE

A recommendation system is one of important applications in the field of artificial intelligence, and can help users find information that the users may be interested in in an information overload environment, and push the information to users who are interested in the information.

A recommendation system in the related technology may determine information in which a user may be interested from a large amount of to-be-recommended information, and recommend, to the user, the information in which the user may be interested. However, accuracy of information recommendation in the related technology needs to be improved.

### SUMMARY

Embodiments of this disclosure provide an information recommendation method and apparatus, an electronic device, a computer-readable storage medium, and a computer program product, so that accuracy of information recommendation can be improved.

Technical solutions of embodiments of this disclosure are implemented as follows:

An embodiment of this disclosure provides an information recommendation method, applied to an electronic device, and including:
obtaining a plurality of field features of a to-be-recommended task, the plurality of field features including at least one item feature of to-be-recommended information and at least one object feature of a target object;
performing layer construction processing on the plurality of field features by using each layer constructor of a multi-layer constructor, to obtain cross features of each layer constructor;
performing weighted aggregation processing on cross features corresponding to the multi-layer constructor, to obtain an aggregated feature of the to-be-recommended task;
performing indicator prediction processing on the aggregated feature of the to-be-recommended task, to obtain a recommendation indicator that corresponds to the target object and that is of the to-be-recommended information; and
performing a recommendation operation based on the recommendation indicator that corresponds to the target object and that is of the to-be-recommended information.

An embodiment of this disclosure provides an information recommendation apparatus, including:
an obtaining module, configured to obtain a plurality of field features of a to-be-recommended task, the plurality of field features including at least one item feature of to-be-recommended information and at least one object feature of a target object;
a layer construction module, configured to perform layer construction processing on the plurality of field features by using each layer constructor of a multi-layer constructor, to obtain cross features of each layer constructor;
an aggregation module, configured to perform weighted aggregation processing on cross features corresponding to the multi-layer constructor, to obtain an aggregated feature of the to-be-recommended task;
a prediction module, configured to perform indicator prediction processing on the aggregated feature of the to-be-recommended task, to obtain a recommendation indicator that corresponds to the target object and that is of the to-be-recommended information; and
a recommendation module, configured to perform a recommendation operation based on the recommendation indicator that corresponds to the target object and that is of the to-be-recommended information.

An embodiment of this disclosure provides an electronic device for information recommendation, the electronic device including:
a memory, configured to store a computer program or computer-executable instructions; and
a processor, configured to implement, when executing the computer program or the computer-executable instructions stored in the memory, the information recommendation method provided in embodiments of this disclosure.

An embodiment of this disclosure provides a computer-readable storage medium, having a computer program or computer-executable instructions stored herein, when the computer program or the computer-executable instructions are executed by a processor, the information recommendation method provided in embodiments of this disclosure being implemented.

An embodiment of this disclosure provides a computer program product, including a computer program or computer-executable instructions. When the computer program or the computer-executable instructions are executed by a processor the information recommendation method provided in embodiments of this disclosure is implemented.

Embodiments of this disclosure have the following beneficial effects:

Layer construction processing is performed on the plurality of field features by using each layer constructor of the multi-layer constructor, to obtain the cross features of each layer constructor. Weighted aggregation processing is performed on the cross features corresponding to the multi-layer constructor, to obtain the aggregated feature of the to-be-recommended task, so that the plurality of field features are fully fused, and accuracy and diversity of aggregated features are improved. In this way, when indicator prediction is performed based on the aggregated features, accuracy of the recommendation indicator can be improved, so that recommendation accuracy can be improved.

### BRIEF DESCRIPTION OF THE DRAWINGS

FIG. 1 is a schematic diagram of an application scenario of a recommendation system according to an embodiment of this disclosure.

FIG. 2 is a schematic diagram of a structure of an electronic device for information recommendation according to an embodiment of this disclosure.

FIG. 3A is a first schematic flowchart of an information recommendation method according to an embodiment of this disclosure.

FIG. 3B is a second schematic flowchart of an information recommendation method according to an embodiment of this disclosure.

FIG. 3C is a third schematic flowchart of an information recommendation method according to an embodiment of this disclosure.

FIG. 3D is a fourth schematic flowchart of an information recommendation method according to an embodiment of this disclosure.

FIG. 4 is a schematic diagram of an advertisement recommendation interface according to an embodiment of this disclosure.

FIG. 5 is a schematic flowchart of an information recommendation method according to an embodiment of this disclosure.

FIG. 6 is a schematic flowchart of an explicit high-order feature crossing model (also referred to as an information recommendation model) according to an embodiment of this disclosure.

FIG. 7A is a first schematic diagram of a feature crossing function according to an embodiment of this disclosure.

FIG. 7B is a second schematic diagram of a feature crossing function according to an embodiment of this disclosure.

FIG. 7C is a third schematic diagram of a feature crossing function according to an embodiment of this disclosure.

FIG. 7D is a fourth schematic diagram of a feature crossing function according to an embodiment of this disclosure.

FIG. 8 is a schematic diagram of a layer constructor according to an embodiment of this disclosure.

FIG. 9A is a first schematic diagram of a layer aggregator according to an embodiment of this disclosure.

FIG. 9B is a second schematic diagram of a layer aggregator according to an embodiment of this disclosure.

FIG. 9C is a third schematic diagram of a layer aggregator according to an embodiment of this disclosure.

### DESCRIPTION OF EMBODIMENTS

To make the objectives, technical solutions, and advantages of this application clearer, the following further describes this application in detail with reference to the accompanying drawings. The described embodiments should not be construed as a limitation to this application. All other embodiments obtained by a person of ordinary skill in the art without creative efforts shall fall within the protection scope of this application.

In the following descriptions, the related term “first/second” is merely intended to distinguish between similar objects, and does not indicate a particular order for the objects. The “first/second” may be interchanged with a particular order or sequence as permitted, so that embodiments of this disclosure described herein can be implemented in an order other than the order shown or described herein.

The following descriptions relate to “some embodiments”, which describes a subset of all possible embodiments. However, the “some embodiments” may be the same subset or different subsets of all possible embodiments, and may be combined with each other in a case of no conflict.

In embodiments of this disclosure, related data such as user information is involved. When embodiments of this disclosure are applied to a specific product or technology, user permission or consent needs to be obtained, and collection, use, and processing of the related data needs to comply with related laws, regulations and standards of related countries and regions.

In embodiments of this disclosure, the term “module” or “unit” refers to a computer program having a predetermined function or a part of the computer program, which works together with other relevant parts to achieve a predetermined objective, and may be all or partially implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in this specification are the same as those generally understood by a person skilled in the technical field to which this application belongs. Terminologies used in this specification are merely intended to describe embodiments of this disclosure, but are not intended to limit this application.

Before embodiments of this disclosure are further described in detail, nouns and terms involved in embodiments of this disclosure are described, and the nouns and terms involved in embodiments of this disclosure are applicable to the following explanations.

(1) Target object: The target object is a user currently using a recommendation system, that is, a current user. For example, if a user A is watching news by using a text recommendation system, the user A is the target object.

(2) Object feature set: The object feature set is configured for delineating a target object and connecting a user demand to a design direction. The object feature set is widely applied to various fields. During actual operation, attributes, behaviors, and expectations that are of a user are usually connected by using words that are most explicit and close to life, as a virtual representation of an actual user.

(3) Recommendation indicator: The recommendation indicator is configured for guiding a recommendation system to perform recommendation, for example, whether a target object clicks on to-be-recommended information, whether the target object is interested in the to-be-recommended information, whether the target object performs conversion based on the to-be-recommended information, or whether the target object evaluates the to-be-recommended information.

(4) To-be-recommended task: The to-be-recommended task is a task corresponding to a recommendation indicator, in other words, a task that a target object needs to perform on to-be-recommended information based on the recommendation indicator. For example, the target object determines, based on the recommendation indicator, whether the to-be-recommended information needs to be recommended, or the target object determines, based on the recommendation indicator, whether a recommendation position of the to-be-recommended information needs to be adjusted.

(5) Click-through rate prediction: The click-through rate prediction is prediction of a click-through situation of to-be-recommended information each time based on information such as given to-be-recommended information (for example, an advertisement), a user, and a context situation.

(6) Deep neural network (DNN): The deep neural network is a type of feedforward neural network having a deep structure, is a technology in the field of machine learning (ML), and can indicate a complex function by using few parameters.

(7) Embedding method: The embedding method is a method of converting discrete variables into continuous vectors for indication. A neural network model generally converts discrete features into embedding vectors, and then uses, after concatenating or other processing, the embedding vectors as an input layer of the neural network model.

(8) Representation: The representation refers to an embedding vector obtained by combining all features in a neural network model, that is, the representation refers to a high-dimensional vector.

(9) Hadamard Product: The Hadamard Product is a matrix multiplication operation. A Hadamard product of matrices A and B is a new matrix, and elements thereof are defined as a product of corresponding elements of the matrices A and B.

Embodiments of this disclosure provide an information recommendation method and apparatus, an electronic device, a computer-readable storage medium, and a computer program product, so that accuracy of recommendation can be improved.

The information recommendation method provided in an embodiment of this disclosure may be independently implemented by a terminal, or implemented by cooperation of the terminal and a server. For example, the terminal independently performs the information recommendation method described below. Alternatively, the terminal sends an information recommendation request for a target object to the server, and the server performs the information recommendation method based on the received information recommendation request for the target object, determines a recommendation indicator that corresponds to the target object and that is of to-be-recommended information, and performs a recommendation operation based on the recommendation indicator that corresponds to the target object and that is of the to-be-recommended information, to respond to the information recommendation request for the target object.

Exemplary application of the electronic device provided in an embodiment of this disclosure is described below. The electronic device provided in this embodiment of this disclosure may be implemented as various types of user terminals such as a notebook computer, a tablet computer, a desktop computer, a set-top box, a mobile device (for example, a mobile phone, a portable music player, a personal digital assistant, a dedicated message device, a portable game device, or an in-vehicle device), a smartphone, a smart speaker, a smartwatch, a smart television, and an in-vehicle terminal. The electronic device may be implemented as an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a field name service, a security service, a content delivery network (CDN), big data, and an artificial intelligence platform. The cloud service may be an information recommendation service, and is invoked by a terminal.

An example of the information recommendation service is used, to be specific, an example in which an information recommendation program provided in an embodiment of this disclosure is encapsulated in a server at a cloud is used. A user invokes the information recommendation service in the cloud service by using a terminal (on which a client, like a news client or a video client, is run), so that the server deployed at the cloud can invoke the encapsulated information recommendation program to: perform layer construction processing on a plurality of field features by using each layer constructor of a multi-layer constructor, to obtain cross features of each layer constructor; perform weighted aggregation processing on cross features corresponding to the multi-layer constructor, to obtain an aggregated feature of a to-be-recommended task; perform indicator prediction (or metric prediction) processing on the aggregated feature of the to-be-recommended task, to obtain a recommendation indicator that corresponds to a target object and that is of to-be-recommended information; and perform a recommendation operation based on the recommendation indicator that corresponds to the target object and that is of the to-be-recommended information. In this way, the to-be-recommended information is distributed to users whose interest requirements the to-be-recommended information satisfies, to improve an effect of the information recommendation. In this disclosure, a layer constructor may also be referred to as a layer assembler.

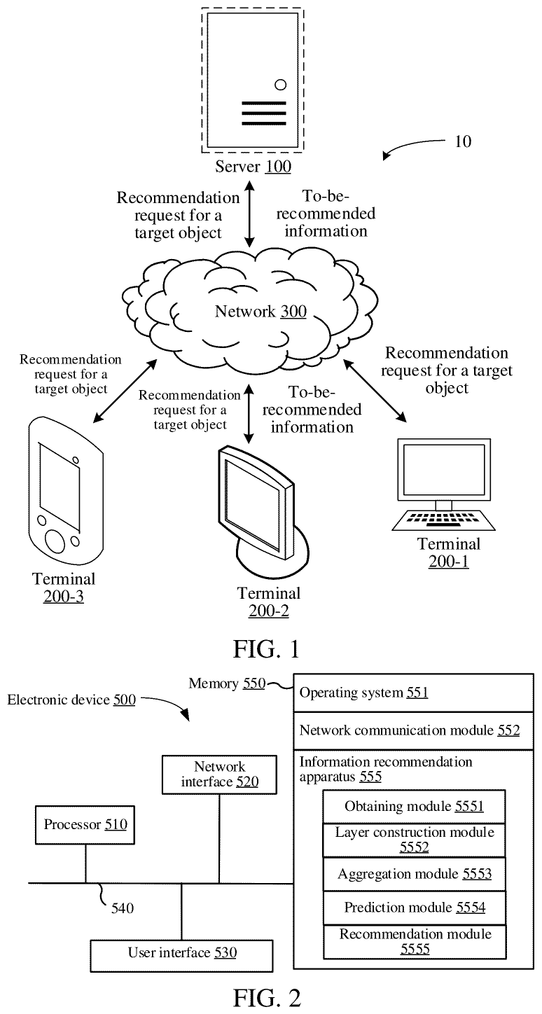

FIG. 1 is a schematic diagram of an application scenario of a recommendation system 10 according to an embodiment of this disclosure. Terminals (a terminal 200-1, a terminal 200-2, and a terminal 200-3 are shown as examples) are connected to a server 100 over a network 300. The network 300 may be a wide area network, a local area network, or a combination thereof.

A terminal (on which a client, like a news client or a video client, is run) may be configured to obtain an information recommendation request for a target object. For example, after the target object opens the video client running on the terminal, the terminal automatically obtains a video recommendation request for the target object.

In some embodiments, after obtaining the information recommendation request for the target object, the terminal invokes an information recommendation interface (which may be provided in a form of a cloud service, that is, an information recommendation service) of the server 100. The server 100 performs, based on the information recommendation request for the target object, layer construction processing on a plurality of field features by using each layer constructor of a multi-layer constructor, to obtain cross features of each layer constructor; performs weighted aggregation processing on cross features corresponding to the multi-layer constructor, to obtain an aggregated feature of a to-be-recommended task; performs indicator prediction (or metric prediction) processing on the aggregated feature of the to-be-recommended task, to obtain a recommendation indicator that corresponds to the target object and that is of to-be-recommended information; and performs a recommendation operation based on the recommendation indicator that corresponds to the target object and that is of the to-be-recommended information. In this way, the to-be-recommended information is distributed to users whose interest requirements the to-be-recommended information satisfies, to improve an effect of the information recommendation.

In some implementations, the layer constructor may alternatively be referred to as layer assembler.

In an application example, for a video application, after a plurality of target objects open video clients running on terminals, the terminals automatically obtain video recommendation requests for the target objects, and invoke information recommendation interfaces of the server 100; and the server 100 performs an artificial intelligence-based information recommendation method, and determines recommendation indicators (for example, whether to click) that respectively correspond to the plurality of target objects and that are of a to-be-recommended video. In this case, the server 100 pre-estimates a click-through rate of the to-be-recommended video based on the recommendation indicators that respectively correspond to the plurality of target objects and that are of the to-be-recommended video. For example, in 100 target objects, 80 target objects may click on the to-be-recommended video, and the click-through rate of the to-be-recommended video is pre-estimated to be 80%. Then, a recommendation position of the to-be-recommended video is adjusted, and the to-be-recommended video is located at a position with good exposure. In this way, the effect of the information recommendation is improved, to respond to the information recommendation request for the target object.

In some embodiments, the client running on the terminal may be implanted with an information recommendation plug-in, to locally implement the artificial intelligence-based information recommendation method at the client. For example, after obtaining the information recommendation request for the target object, the terminal invokes the information recommendation plug-in, to implement the information recommendation method. The terminal performs layer construction processing on the plurality of field features by using each layer constructor of the multi-layer constructor, to obtain the cross features of each layer constructor; performs weighted aggregation processing on the cross features corresponding to the multi-layer constructor, to obtain the aggregated feature of the to-be-recommended task; performs indicator prediction (or metric prediction) processing on the aggregated feature of the to-be-recommended task, to obtain the recommendation indicator that corresponds to the target object and that is of the to-be-recommended information; and performs the recommendation operation based on the recommendation indicator that corresponds to the target object and that is of the to-be-recommended information. In this way, the to-be-recommended information is distributed to the users whose interest requirements the to-be-recommended information satisfies, to improve the effect of the information recommendation.

In an application example, for a news application, after a target object opens a news client running on a terminal, the terminal automatically obtains a news recommendation request for the target object, invokes the information recommendation plug-in, executes the information recommendation method based on a plurality of recommendation features of a to-be-recommended task, and determines a recommendation indicator (for example, whether to click) that corresponds to the target object and that is of to-be-recommended news. When the recommendation indicator that corresponds to the target object and that is of the to-be-recommended news represents that the target object is to click on the to-be-recommended news, the to-be-recommended task is executed, so that the effect of the information recommendation is improved, to respond to the information recommendation request for the target object.

In some embodiments, a terminal or a server may implement the information recommendation method provided in embodiments of this disclosure by running various computer-executable instructions or computer programs. For example, the computer-executable instructions may be microprogram-level commands, machine instructions, or software instructions. The computer program may be a native program or a software module in an operating system. The computer program may be a native application (APP), to be specific, a program that can be run only when installed in the operating system, for example, a live streaming application or an instant messaging application. Alternatively, the computer program may be a mini-program embedded in any APP, to be specific, a program that can be run merely after being downloaded into a browser environment. In conclusion, the foregoing computer-executable instructions may be instructions in any form, and the foregoing computer program may be an application, a module, or a plug-in in any form.

The following describes a structure of an electronic device for information recommendation provided in an embodiment of this disclosure. FIG. 2 is a schematic diagram of a structure of an electronic device 500 for information recommendation according to an embodiment of this disclosure. An example in which the electronic device 500 is a terminal is used for description. The electronic device 500 for information recommendation shown in FIG. 2 includes: at least one processor 510, a memory 550, at least one network interface 520, and a user interface 530. Components in the electronic device 500 are coupled together through a bus system 540. The bus system 540 is configured to implement connection and communication between these components. In addition to a data bus, the bus system 540 further includes a power bus, a control bus, and a state signal bus. However, for clear illustration, all types of buses are marked as the bus system 540 in FIG. 2.

The processor 510 may be an integrated circuit chip having a signal processing capability, for example, a general-purpose processor, a digital signal processor (DSP), or another programmable logic device, discrete gate, transistor logic device, or discrete hardware component. The general-purpose processor may be a microprocessor, any conventional processor, or the like.

The memory 550 includes a volatile memory or a non-volatile memory, or may include both the volatile memory and the non-volatile memory. The non-volatile memory may be a read-only memory (ROM), and the volatile memory may be a random access memory (RAM). The memory 550 described in this embodiment of this disclosure is intended to include a memory of any suitable type. In some embodiments, the memory 550 includes one or more storage devices located at a physical position far away from the processor 510.

In some embodiments, the memory 550 can store data to support various operations. Examples of the data include a program, a module, and a data structure, or a subset or a superset thereof. Exemplary descriptions are as follows:

An operating system 551 includes a system program configured to process various basic system services and perform hardware-related tasks, for example, a framework layer, a core library layer, and a driver layer, to implement various basic services and process hardware-based tasks.

A network communication module 552 is configured to reach another electronic device through one or more (wired or wireless) network interfaces 520. An exemplary network interface 520 includes Bluetooth, wireless compatibility authentication (Wi-Fi), a universal serial bus (USB), and the like.

In some embodiments, an information recommendation apparatus provided in embodiments of this disclosure may be implemented in a software manner. The information recommendation apparatus provided in embodiments of this disclosure may be provided in various software embodiments, including various forms such as an application, software, a software module, a script, or code.

FIG. 2 shows an information recommendation apparatus 555 stored in the memory 550. The information recommendation apparatus 555 may be software in a form of a program, a plug-in, and the like, and includes a series of modules, including an obtaining module 5551, a layer construction module 5552, an aggregation module 5553, a prediction module 5554, and a recommendation module 5555. These modules are logical, and therefore may be randomly combined or further split based on an implemented function. Functions of the modules are described below.

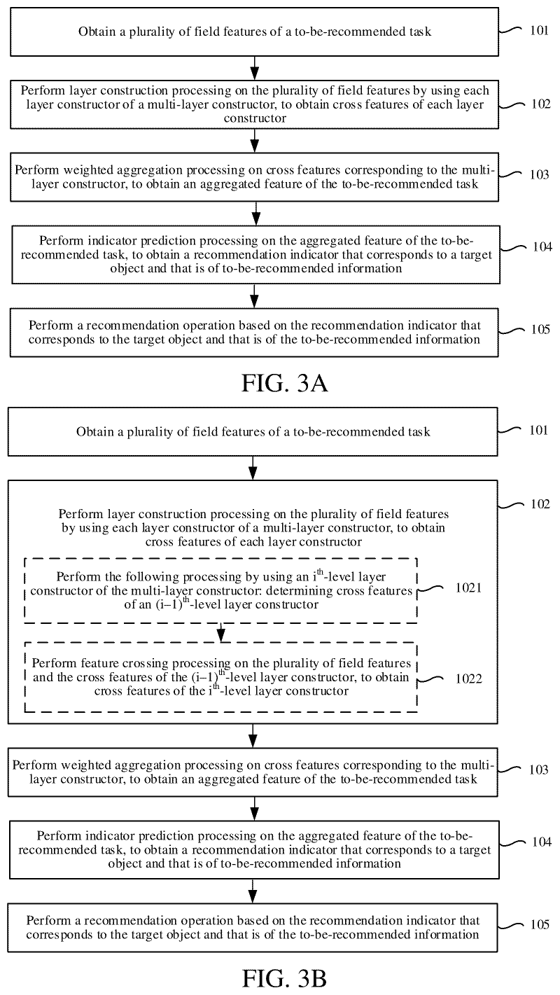

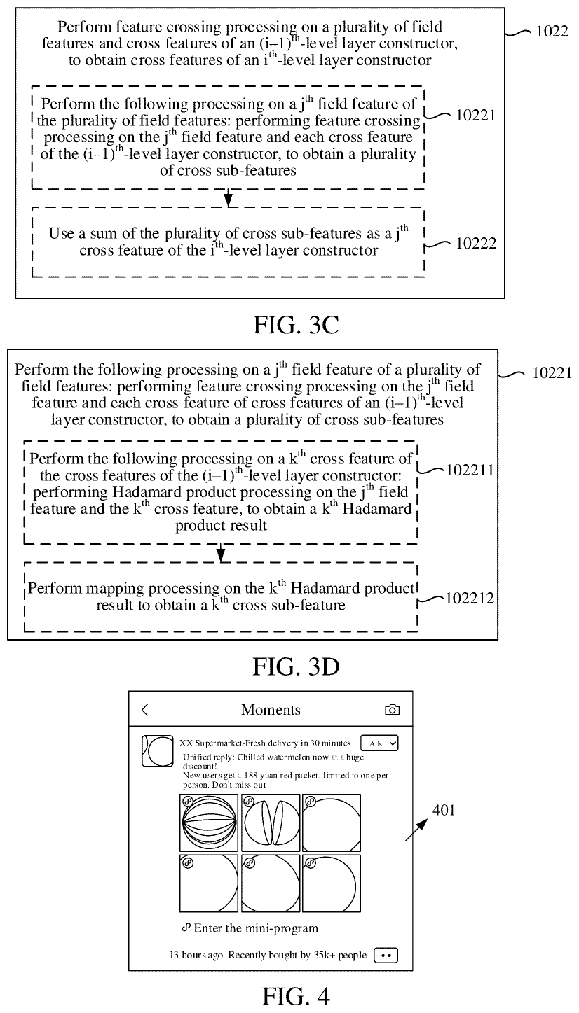

As described above, the information recommendation method provided in embodiments of this disclosure may be implemented by various types of electronic devices, such as a terminal, a server, or a combination thereof. Therefore, an execution body of each operation is not repeatedly described below. FIG. 3A is a schematic flowchart of an information recommendation method according to an embodiment of this disclosure. Descriptions are provided with reference to the operations shown in FIG. 3A.

In the following operations, to-be-recommended information may be data such as a text, an image, an image and text, or a video. A recommendation indicator is an indicator configured for guiding a recommendation system to perform recommendation, for example, whether a target object clicks on the to-be-recommended information, whether the target object is interested in the to-be-recommended information, whether the target object performs conversion based on the to-be-recommended information, or whether the target object evaluates the to-be-recommended information; or a probability that the target object clicks on the to-be-recommended information, a probability that the target object is interested in the to-be-recommended information, a probability that the target object performs conversion based on the to-be-recommended information, or a probability that the target object evaluates the to-be-recommended information.

In operation 101, a plurality of field features of a to-be-recommended task are obtained, the plurality of field features including at least one item feature of to-be-recommended information and at least one object feature of a target object.

The to-be-recommended task is a task corresponding to a to-be-predicted recommendation indicator. For example, when the to-be-predicted recommendation indicator is the probability that the target object clicks on the to-be-recommended information, the to-be-recommended task is whether to recommend the to-be-recommended information to the target object. When the to-be-predicted recommendation indicator is the probability that the target object evaluates the to-be-recommended information, the to-be-recommended task is whether to adjust a position of the to-be-recommended information to a comment area, to facilitate commenting or the like of the target object on the to-be-recommended information.

In an example of obtaining the item feature, feature extraction processing is performed on the to-be-recommended information in an offline manner or an online manner, to obtain an item feature (for example, an advertisement side feature) of the to-be-recommended information. For example, the item feature is configured for representing a feature of the to-be-recommended information. For example, the item feature includes a category, a price, and the like of the to-be-recommended information.

In an example of obtaining the object feature, feature extraction processing is performed on an object feature set of the target object in an offline manner or an online manner, to obtain an object feature (for example, a user side feature) of the target object. For example, the object feature is configured for representing a feature of the target object. For example, the object feature includes an age, a preference, a gender, and the like of a target user.

In some embodiments, the plurality of field features further includes a context feature of the to-be-recommended task. The context feature is configured for representing a real-time feature of the to-be-recommended task, for example, a current time, information about an electronic device currently used by the target object, or a current real-time geographical location of the target object.

In an example of obtaining the field feature, after the field feature of the to-be-recommended task is pre-extracted in an offline manner, the target object opens a client running on a terminal, and the terminal automatically obtains an information recommendation request (including an identifier of the target object) for the target object, and obtains a pre-extracted field feature of the to-be-recommended task based on the information recommendation request for the target object, to subsequently perform a layer construction operation based on the field feature of the to-be-recommended task.

In operation 102, layer construction processing is performed on the plurality of field features by using each layer constructor of a multi-layer constructor, to obtain cross features of each layer constructor.

Each layer constructor is configured to construct, by using cross features (to be specific, terms processed by a feature crossing function) outputted by a previous-level layer constructor and the plurality of field features, cross terms configured for being inputted to a next-level layer constructor. Layer construction processing is configured for cross-feature calculating on the plurality of field features based on each layer constructor. A first-level layer constructor is configured to construct, by using the plurality of field features, cross terms for being inputted to a second-level layer constructor. That is, cross features outputted by the first-level layer constructor is terms obtained through processing the plurality of field features by using the feature crossing function.

Interaction (that is, layer construction processing) is performed on the field features by using each layer constructor, to obtain the cross features (also referred to as cross terms, that is, terms processed by the feature crossing function) of each layer constructor. Aggregation processing is performed based on the cross features of each layer constructor. A term in the first-level layer constructor refers to each field feature, and a term in another layer constructor refers to a term constructed by using the layer constructor.

A form of a layer constructor is not limited in this embodiment of this disclosure. For example, the layer constructor may alternatively include a global layer constructor (Layer Assembler with Global-wise Terms, AGT). Global layer construction processing may be performed, by using each global layer constructor, on the plurality of field features, to obtain the cross features of each layer constructor. An i^{th}-level global layer constructor includes K terms in total (where K is equal to a quantity of field features), and a k^{th} term in an i^{th} layer is equal to a calculation result of summation after feature crossing is performed on all cross features of a first layer and each cross feature of an (i−1)^{th} layer. That is, the k^{th} term includes i^{th}-order cross terms of all fields. 1≤k≤K, and k and K are positive integers. The AGT may combine information at both a local (layer-wise) and global (across the entire model) level to improve performance. It extends the capabilities of standard neural networks, such as Transformers, by providing a mechanism for integrating broader contextual information.

FIG. 3B is a schematic flowchart of an information recommendation method according to an embodiment of this disclosure. FIG. 3B shows that operation 102 in FIG. 3A may be implemented by using operations 1021 and 1022. In operation 1021, the following processing is performed by using an i^{th}-level layer constructor of the multi-layer constructor: determining cross features of an (i−1)^{th}-level layer constructor, when the (i−1)^{th}-level layer constructor is the first-level layer constructor, the cross features of the (i−1)^{th}-level layer constructor being the plurality of field features. In operation 1022, feature crossing processing is performed on the plurality of field features and the cross features of the (i−1)^{th}-level layer constructor, to obtain cross features of the i^{th}-level layer constructor, i being a sequentially ascending positive integer, 1<i≤I, and I being a quantity of layers of the multi-layer constructor. Note that the operation may be an iteration that iterates for all “i” in the range of 1<i<I. Exemplarily, the operation may be performed in a for loop (e.g., for i=1; i<=I, i++)).

Feature crossing processing of each layer constructor is configured for performing feature crossing on cross features outputted by a previous-level layer constructor, to obtain cross features of the layer constructor. Feature crossing means that at least two features (for example, a field feature and a cross feature) are combined to create a new feature. In this way, interaction that may exist between original features may be captured, to improve a prediction capability of a model.

For example, cross features of a first-level layer constructor are a plurality of field features, and feature crossing processing is performed on the plurality of field features and the cross features of the first-level layer constructor by using a second-level layer constructor, to obtain cross features of the second-level layer constructor. Feature crossing processing is performed on the plurality of field features and the cross features of the second-level layer constructor by using a third-level layer constructor, to obtain cross features of the third-level layer constructor. The rest can be deduced by analogy, to determine cross features of each layer constructor.

In this embodiment of this disclosure, abstract features of the field features are fully integrated through feature crossing processing of the multi-layer constructor, so that the model can better understand deep meanings of the field features, and more complex internal relationships between the field features are captured. This improves the prediction capability of the model.

FIG. 3C is a schematic flowchart of an information recommendation method according to an embodiment of this disclosure. FIG. 3C shows that operation 1022 in FIG. 3B may be implemented by using operations 10221 and 10222. In operation 10221, the following processing is performed on a j^{th} field feature of the plurality of field features: performing feature crossing processing on the j^{th} field feature and each cross feature of cross features of the (i−1)^{th}-level layer constructor, to obtain a plurality of cross sub-features. In operation 10222, a sum of the plurality of cross sub-features is used as a j^{th} cross feature of the i^{th}-level layer constructor, j being a positive integer, 1≤j≤J, and J being a quantity of the plurality of field features.

The layer constructor may be a feature field-based layer constructor (Layer Assembler (or Layer constructor) with Field-wise Terms, AFT). Feature field-based layer construction processing may be performed on the plurality of field features by using the feature field-based layer constructor, to obtain cross features of each layer constructor. An i^{th}-level AFT includes J terms in total (where J is equal to a quantity of the field features). A j^{th} term (that is, a j^{th} cross feature) in the i^{th} layer is equal to a calculation result of summation after feature crossing is performed on the j^{th} term of the first-level AFT and each cross feature of the (i−1)^{th} layer. That is, the j^{th} term includes all i^{th}-order cross terms related to the j^{th} field.

A form of feature crossing is not limited in this embodiment of this disclosure. For example, the feature crossing may be implemented by using a Hadamard product, polynomial feature crossing, Cartesian product crossing, or the like. The polynomial feature crossing is the simplest feature crossing method. A new feature is created by combining powers of features. For example, if there are two features: A and B, a new feature like A², B², A*B may be created. The Cartesian product crossing is the most direct feature crossing method. All possible combinations of a plurality of features are generated as new features. For example, if there are three features: A, B, and C, the new features are combinations of A, B, and C, including A*B, A*C, B*C, A*B*C, and the like.

In some embodiments, operation 10221 may be implemented in the following manner: performing the following processing on a k^{th} cross feature of the cross features of the (i−1)^{th}-level layer constructor: performing Hadamard product processing on the j^{th} field feature and the k^{th} cross feature, to obtain a k^{th} cross sub-feature, k being a positive integer, and 1≤k≤J.

The Hadamard product processing is configured for calculating a Hadamard product between two features. For example, Hadamard product processing is performed on the j^{th} field feature and the k^{th} cross feature, that is, a Hadamard product between the j^{th} field feature and the k^{th} cross feature is calculated. The Hadamard product refers to a summation result obtained through multiplexing corresponding elements of two matrices of the same dimension. Different from the conventional matrix multiplication, which calculates a linear combination between row and column elements of two matrices, the Hadamard product means that elements at corresponding positions are directly multiplied.

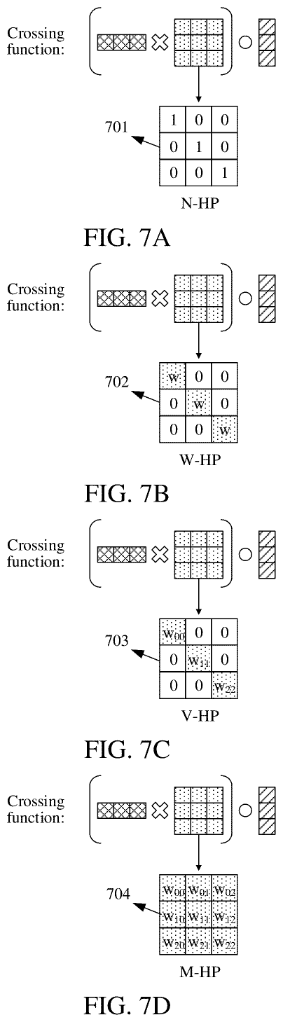

For example, a feature crossing function, namely, a naive Hadamard product (N-HP) may be used in this embodiment of this disclosure. A Hadamard product between two terms (to be specific, the j^{th} field feature and the k^{th} cross feature) is directly calculated, to obtain the k^{th} cross sub-feature. As shown in FIG. 7A, in this embodiment of this disclosure, a calculation process of the Hadamard product may be converted into mapping of the two terms (to be specific, the j^{th} field feature and the k^{th} cross feature) by using an N-HP matrix. The N-HP matrix is an N*N unit matrix, and N is a dimension of the j^{th} field feature or the k^{th} cross feature. For example, when the two terms are both 3*3 matrices, the N-HP matrix 701 is

$$[ \begin{matrix}1 & 0 & 0 \\ 0 & 1 & 0 \\ 0 & 0 & 1\end{matrix} ] .$$

FIG. 3D is a schematic flowchart of an information recommendation method according to an embodiment of this disclosure. FIG. 3D shows that operation 10221 in FIG. 3C may be implemented by using operations 102211 and 102212. In operation 102211, the following processing is performed on the k^{th} cross feature of the cross features of the (i−1)^{th}-level layer constructor: performing Hadamard product processing on the j^{th} field feature and the k^{th} cross feature, to obtain a k^{th} Hadamard product result. In operation 102212, mapping processing is performed on the k^{th} Hadamard product result to obtain the k^{th} cross sub-feature, k being a positive integer, and 1≤k≤J.

In some embodiments, operation 102212 may be implemented in the following manner: determining a field pair-wise scaling weight corresponding to each element in the k^{th} Hadamard product result; and performing weighting processing on each element in the k^{th} Hadamard product result based on the field pair-wise scaling weight, to obtain the k^{th} cross sub-feature.

Each element in the k^{th} Hadamard product result is calculated by using a pair of fields (also referred to as terms): the j^{th} field feature and the k^{th} cross feature. Therefore, a field pair-wise scaling weight corresponding to each element in the k^{th} Hadamard product result is a weight corresponding to the pair of fields: the j^{th} field feature and the k^{th} cross feature.

For example, a feature crossing function, namely, a field pair-wise weight scaled Hadamard product (W-HP) may be used in this embodiment of this disclosure. After the Hadamard product between the two terms (to be specific, the j^{th} field feature and the k^{th} cross feature) is calculated, each element in a calculation result of the Hadamard product (that is, the k^{th} Hadamard product result) is multiplied by a same field pair-wise scaling weight, to obtain the k^{th} cross sub-feature. The field pair-wise scaling weight refers to a weight coefficient that can be learned by each pair of fields (also referred to as terms) to capture importance of the field pair. As shown in FIG. 7B, in this embodiment of this disclosure, a calculation process of the field pair-wise weight scaled Hadamard product may be converted into mapping of the two terms (to be specific, the j^{th} field feature and the k^{th} cross feature) by using a W-HP matrix. The W-HP matrix is an N*N unit matrix, and N is a dimension of the j^{th} field feature or the k^{th} cross feature. For example, when the two terms are both 3*3 matrices, the N-HP matrix 702 is

$$[ \begin{matrix}w & 0 & 0 \\ 0 & w & 0 \\ 0 & 0 & w\end{matrix} ] ,$$

and w indicates the field pair-wise scaling weight.

In this embodiment of this disclosure, the field pair-wise weight scaled Hadamard product technology is used, with reference to concepts of the Hadamard product and weighting scaling, to improve performance of a model on a field. During field adaptation, the Hadamard product may be configured for calculating a cross product of a pair of field features, to capture interaction between features of two fields. The weighting scaling is a policy, and learning behaviors of the model on two fields are adjusted by allocating different weights to the pair of field features. This policy may help the model better pay attention to the field features, and reduce a distribution difference between the two fields. The distribution difference between the two fields is effectively processed, so that a generalization capability of the model on the two fields can be significantly improved by using the field pair-wise weight scaled Hadamard product.

In some embodiments, operation 102212 may be implemented in the following manner: determining a field pair-wise scaling vector corresponding to the k^{th} Hadamard product result; and using a product of the field pair-wise scaling vector and the k^{th} Hadamard product result as the k^{th} cross sub-feature.

The k^{th} Hadamard product result is calculated by using the pair of fields (also referred to as terms): the j^{th} field feature and the k^{th} cross feature. Therefore, the field pair-wise scaling vector corresponding to the k^{th} Hadamard product result is a weighting vector corresponding to the pair of fields: the j^{th} field feature and the k^{th} cross feature.

For example, a feature crossing function, namely, a field pair-wise vector scaled Hadamard product (V-HP) may be used in this embodiment of this disclosure. After a Hadamard product between the two terms (to be specific, the j^{th} field feature and the k^{th} cross feature) is calculated, a calculation result of the Hadamard product (that is, the k^{th} Hadamard product result) is multiplied by a field pair-wise scaling vector, to obtain the k^{th} cross sub-feature. The field pair-wise scaling vector refers to a vector (whose dimension is K, where K indicates a dimension of an embedding vector of a field feature) that can be learned by each pair of fields, and is configured for performing conversion during interaction of the two terms. As shown in FIG. 7C, in this embodiment of this disclosure, a calculation process of the field pair-wise vector scaled Hadamard product may be converted into mapping of two terms (to be specific, the j^{th} field feature and the k^{th} cross feature) by using a V-HP matrix. The V-HP matrix is an N*N matrix, and N is a dimension of the j^{th} field feature or the k^{th} cross feature. For example, when the two terms are both 3*3 matrices, the V-HP matrix 703 is

$$[ \begin{matrix}{w}_{00} & 0 & 0 \\ 0 & {w}_{11} & 0 \\ 0 & 0 & {w}_{22}\end{matrix} ] ,$$

where [w₀₀ w₁₁ w₂₂] indicates a field pair-wise scaling vector.

In this embodiment of this disclosure, feature vectors of the two fields are scaled by using the field pair-wise vector scaled Hadamard product technology, to adjust distributions of the feature vectors, so that a difference between the fields is reduced. This scaling may be implemented by learning a scaling vector. The vector may perform linear transformation on the feature vectors of the two fields, so that distributions of the feature vectors in the two fields are more similar. A distribution difference between the two fields is effectively processed, so that a generalization capability of a model on a target field can be significantly improved by using the field pair-wise vector scaled Hadamard product.

In some embodiments, operation 10221 may be implemented in the following manner: performing the following processing on a k^{th} cross feature of the cross features of the (i−1)^{th}-level layer constructor: determining a field pair-wise projecting matrix corresponding to the j^{th} field feature; performing matrix transformation processing on the j^{th} field feature based on the field pair-wise projecting matrix, to obtain a transformed j^{th} field feature; and performing Hadamard product processing on the transformed j^{th} field feature and the k^{th} cross feature, to obtain a k^{th} cross sub-feature, k being a positive integer, and 1≤k≤J.

The field pair-wise projecting matrix corresponding to the j^{th} field feature uses a concept of matrix projecting to map the j^{th} field feature to space corresponding to another field feature (for example, the k^{th} cross feature). During field adaptation, the field pair-wise projecting matrix may be configured for adjusting feature distribution in two fields, to reduce a difference between fields.

For example, a feature crossing function, namely, a field pair-wise matrix projected Hadamard product (M-HP) may be used in this embodiment of this disclosure. One of the two terms (to be specific, the j^{th} field feature and the k^{th} cross feature) on which feature crossing is performed is transformed by using one field pair-wise projecting matrix, and then a Hadamard product between the transformed term and the other term is calculated, to obtain the k^{th} cross sub-feature. The field pair-wise projecting matrix refers to a matrix (whose dimension is K*K, where K indicates a dimension of an embedding vector of a field feature) that can be learned by two terms, and is configured for performing conversion on feature embeddings of the two terms during interaction. As shown in FIG. 7D, in this embodiment of this disclosure, a calculation process of the field pair-wise matrix projected Hadamard product may be converted into mapping of the two terms (to be specific, the j^{th} field feature and the k^{th} cross feature) by using an M-HP matrix. The M-HP matrix is an N*N matrix, and N is a dimension of the j^{th} field feature or the k^{th} cross feature. For example, when the two terms are both 3*3 matrices, the V-HP matrix 704 is

$$[ \begin{matrix}{w}_{00} & {w}_{01} & {w}_{02} \\ {w}_{10} & {w}_{11} & {w}_{12} \\ {w}_{20} & {w}_{21} & {w}_{22}\end{matrix} ] .$$

Continuing operation 102, in operation 103, weighted aggregation processing is performed on cross features corresponding to the multi-layer constructor, to obtain an aggregated feature of the to-be-recommended task.

Weighted aggregation processing of a layer aggregator is configured for performing weighted aggregation on the cross features corresponding to the multi-layer constructor, to obtain the aggregated feature. The weighted aggregation processing is performed, by using the layer aggregator, on the cross features corresponding to the multi-layer constructor, to obtain the aggregated feature of the to-be-recommended task, so that the field features are sufficiently and effectively aggregated by using the aggregated feature, to subsequently perform indicator prediction (or metric prediction) based on the accurate aggregated feature. In this way, an accurate recommendation indicator can be obtained.

A form of the layer aggregator is not limited in this embodiment of this disclosure. For example, the layer aggregator may be implemented in manners of concatenating, average pooling, max pooling, and the like. The concatenating is the simplest form of the layer aggregator, and cross features from different layer constructors are concatenated in dimension, to form a new feature vector (that is, an aggregated feature). The average pooling is to perform average pooling on cross features from different layer constructors, to generate a new feature vector. The max pooling is to perform max pooling on cross features from different layer constructors, to generate a new feature vector.

In some embodiments, operation 103 may be implemented in the following manners: determining a layer weight of each layer constructor; performing, based on the layer weight of each layer constructor, weighting processing on the cross features corresponding to the multi-layer constructor, to obtain weighted cross features corresponding to the multi-layer constructor; and performing concatenating processing on the weighted cross features corresponding to the multi-layer constructor, to obtain the aggregated feature of the to-be-recommended task.

For example, a layer aggregator, namely, a layer aggregator with order-wise weight (Agg-O) may be used in this embodiment of this disclosure. Cross features outputted by all layer constructors are all multiplied by a weight (that is, the layer weight) associated with an order, to obtain the weighted cross features corresponding to the multi-layer constructor. Then, the weighted cross features corresponding to the multi-layer constructor are concatenated, to obtain the aggregated feature (also referred to as a representation) of the to-be-recommended task. The weight associated with the order is a learnable parameter. As shown in FIG. 9A, the layer aggregator with order-wise weight in this embodiment of this disclosure separately multiplies embedding vectors of the cross features outputted by the layer constructors by a weight associated with an order.

In this embodiment of this disclosure, sequence and importance of cross features at different levels are considered by using the layer aggregator with order-wise weight, and different weights are allocated to cross features at each level, to help the model to better understand and use the cross features at different levels, so that performance and a generalization capability of the model are improved.

In some embodiments, operation 103 may be implemented in the following manners: determining a term weight of each cross feature of each layer constructor; performing weighting processing on each cross feature of each layer constructor based on the term weight of each cross feature of each layer constructor, to obtain weighted cross features of each layer constructor; and performing concatenating processing on weighted cross features corresponding to the multi-layer constructor, to obtain the aggregated feature of the to-be-recommended task.

For example, a layer aggregator, namely, a layer aggregator with term-wise weight (Agg-T) may be used in this embodiment of this disclosure. Each term in the cross features outputted by all layer constructors is multiplied by a weight (that is, the term weight) associated with the term, to obtain the weighted cross features of each layer constructor. Then, the weighted cross features corresponding to the multi-layer constructor are concatenated, to obtain the aggregated feature (also referred to as a representation) of the to-be-recommended task. The weight associated with the term is a learnable parameter. As shown in FIG. 9B, the layer aggregator with term-wise weight in this embodiment of this disclosure multiplies each term in embedding vectors of the cross features outputted by the layer constructors by a weight associated with the term.

In this embodiment of this disclosure, each term (that is, each cross feature) is allocated with a weight by using the layer aggregator with term-wise weight, to emphasize or suppress contributions of different cross features to an aggregation result. In the multi-layer constructor, a large quantity of cross features may be generated on each layer. These cross features may have different importance and indication capabilities. The layer aggregator with term-wise weight aims to learn a weight of each cross feature, to highlight a feature that is helpful to a recommendation indicator, and suppress a feature that is unfavorable to the recommendation indicator. The layer aggregator with term-wise weight can automatically learn importance of each cross feature, and use these cross features to enhance the performance and the generalization capability of the model.

In some embodiments, operation 103 may be implemented in the following manners: determining an element weight of each element in each cross feature of each layer constructor; performing weighting processing on each element in each cross feature of each layer constructor based on the element weight of each element in each cross feature of each layer constructor, to obtain weighted cross features of each layer constructor; and performing concatenating processing on weighted cross features corresponding to the multi-layer constructor, to obtain the aggregated feature of the to-be-recommended task.

For example, a layer aggregator, namely, a layer aggregator with element-wise weight (Agg-E) may be used in this embodiment of this disclosure. Each element in each of the cross features outputted by all layer constructors is multiplied by a weight (that is, the element weight) associated with the element, to obtain the weighted cross features of each layer constructor. Then, the weighted cross features corresponding to the multi-layer constructor are concatenated, to obtain the aggregated feature (also referred to as a representation) of the to-be-recommended task. The weight associated with the element is a learnable parameter. As shown in FIG. 9C, the layer aggregator with element-wise weight in this embodiment of this disclosure multiplies each element in embedding vectors of the cross features outputted by the layer constructors by a weight associated with the element.

In this embodiment of this disclosure, an element (that is, each cross feature) is allocated with a weight by using the layer aggregator with term-wise weight (or element-wise weight), to emphasize or suppress contributions of different elements to an aggregation result. In the multi-layer constructor, a large quantity of cross features may be generated on each layer. These cross features may have different dimensions and indication capabilities. The layer aggregator with element-wise weight aims to learn a weight of each element, to highlight a dimension of a feature that is helpful to a recommendation indicator, and suppress a dimension of a feature that is unfavorable to the recommendation indicator. The layer aggregator with element-wise weight may enhance a feature aggregation capability by allocating a weight to each feature element. This method may help the model to better understand and use different feature dimensions, to improve the performance and the generalization capability of the model.

In operation 104, indicator prediction (or metric prediction) processing is performed on the aggregated feature of the to-be-recommended task, to obtain a recommendation indicator that corresponds to the target object and that is of the to-be-recommended information.

The indicator prediction (or metric prediction) processing is configured for classifying an aggregated feature by using a classifier, to obtain the recommendation indicator that corresponds to the target object and that is of the to-be-recommended information. For example, after the aggregated feature of the to-be-recommended task is obtained, the indicator prediction (or metric prediction) processing is performed on the aggregated feature of the to-be-recommended task by using the classifier, to obtain the recommendation indicator that corresponds to the target object and that is of the to-be-recommended information, for example, whether the target object clicks on to-be-recommended information, whether the target object is interested in the to-be-recommended information, whether the target object performs conversion based on the to-be-recommended information, or whether the target object evaluates the to-be-recommended information. In this way, the to-be-recommended task is executed based on the recommendation indicator that corresponds to the target object and that is of the to-be-recommended information, to improve accuracy of information recommendation.

A form of the classifier is not limited in this embodiment of this disclosure. For example, the classifier may be a decision tree classifier, a random forest classifier, or a support vector machine. The decision tree classifier is a classifier based on a tree structure, and divides aggregated features by using a series of rules until each leaf node includes only data that belongs to one category. The random forest classifier includes a plurality of decision tree classifiers, each decision tree is trained by randomly extracting and dividing data features, and the random forest improves classification accuracy in a voting manner. The support vector machine is a binary classifier, and two categories of data are separated by finding an optimal hyper-plane, so that data points are distributed on two sides of the hyper-plane as many as possible.

In operation 105, a recommendation operation is performed based on the recommendation indicator that corresponds to the target object and that is of the to-be-recommended information.

For example, after the recommendation indicator that corresponds to the target object and that is of the to-be-recommended information is obtained, the to-be-recommended task is executed based on the recommendation indicator that corresponds to the target object and that is of the to-be-recommended information. For example, when the recommendation indicator that corresponds to the target object and that is of the to-be-recommended information represents that the target object may click on the to-be-recommended information, the recommendation operation is executed, to present the to-be-recommended information to the target object, so that an effect of information recommendation is improved.

Exemplary application of this embodiment of this disclosure in an actual application scenario is described below.

This embodiment of this disclosure may be applied to personalized recommendation such as e-commerce shopping, video (or music) recommendation, news information flow recommendation, and a life service scenario. Online advertising is the most direct and transparent manner of traffic monetization for most Internet companies. Moments advertisement is used as an example. As shown in FIG. 4, when a user opens a dynamic refreshing list, an advertisement system selects an appropriate advertisement 401 from an advertisement library for recommendation and presentation. After the advertisement is presented to the user, when the user clicks the advertisement and even performs conversion behaviors such as activating an APP and placing an order, the system may automatically deduct a fee for an advertiser. In this way, traffic monetization is implemented.

Precise advertisement recommendation can help the advertiser to identify potential customers more rapidly, to improve advertising efficiency, so that the use of resources is maximized, and user experience can be further improved. Therefore, a win-win of three parties: the advertiser, an advertisement platform, and the user is achieved. In this scenario, this embodiment of this disclosure provides a unified explicit high-order feature crossing model (referred to as a model for short). A representation part of the model includes three components, namely, a feature crossing function, a layer constructor, and a layer aggregator. Then, an output of the representation part is passed through a classifier to obtain a prediction result. The model mainly uses a feature crossing method to model relationships between features of different fields on a user side, an advertisement side, and a context side. The more efficient explicit high-order feature crossing model can be used to control space and time complexity of the model, and improve prediction accuracy of the model, to improve effectiveness of the advertiser.

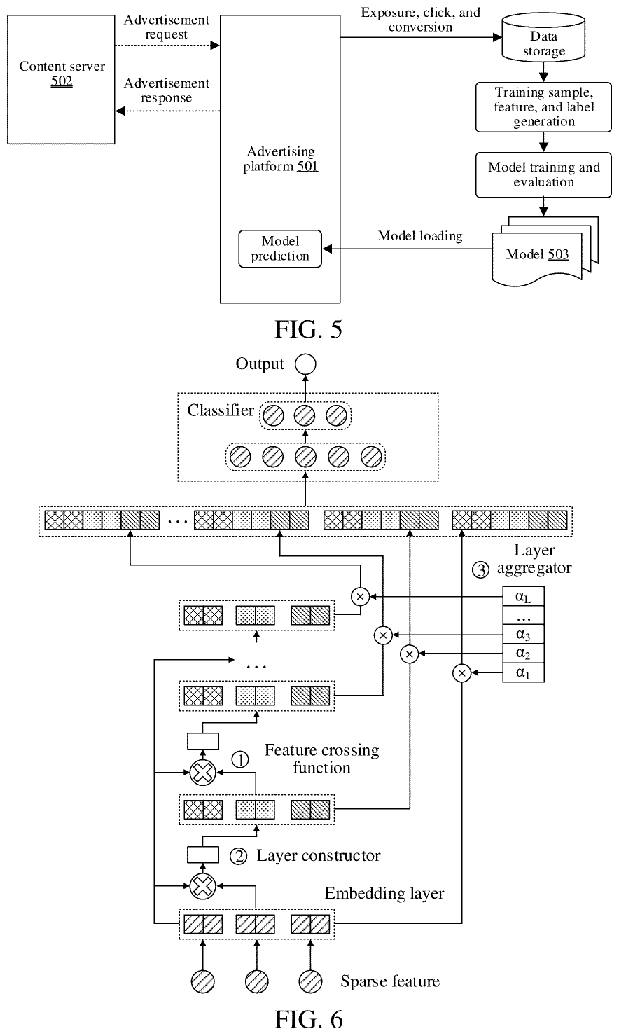

As shown in FIG. 5, in an online advertisement service scenario, an advertisement platform 501 receives an advertisement request of a content server 502, and then selects a most appropriate advertisement from an advertisement library to return and present the advertisement. All data, such as advertisement exposure, click, and conversion, generated in this process is stored for periodic model training. Each trained model 503 is loaded to a server of the advertisement platform 501 for prediction of a real-time advertisement click-through rate (CTR) and conversion rate (CVR).

The following describes construction of training samples and features.

For a click-through rate model, a probability that a user clicks an advertisement after the advertisement is presented is predicted by using the CTR model. Therefore, a training sample for training the CTR model is a single advertisement exposure record of the user. A label is determined depending on whether the user clicks the advertisement. A clicked advertisement sample is marked as a positive sample (y=1), and a non-clicked advertisement sample is marked as a negative sample (y=0).

For a conversion rate model, a probability that a user performs conversion after clicking an advertisement is predicted by using the CVR model. Therefore, a training sample for training the CVR model is a single advertisement click record of the user, and a label is determined depending on whether the user performs conversion. For each conversion of the user, if a click operation in a given window before the conversion can be found, the advertisement sample is marked as a positive sample. If no click operation is found, the advertisement sample is marked as a negative sample.

Features of each sample include a user side feature, an advertisement side feature, and a context feature. All features are discrete, and features that are originally continuous values are discretized into discrete features.

As shown in FIG. 6, an example in which the explicit high-order feature crossing model is configured to predict an advertisement click-through rate is used for description. The explicit high-order feature crossing model includes a feature crossing function, a layer constructor, and a layer aggregator. The feature crossing function, the layer constructor, and the layer aggregator are separately described below.

Before processing by using the feature crossing function and the layer constructor is performed, sparse feature preprocessing may be performed on the user side feature, the advertisement side feature, and the context feature, to convert the user side feature, the advertisement side feature, and the context feature into embedding vectors of a fixed dimension, so that sparse features can be obtained.

(1) Feature crossing function: For each term (where a term on the first layer refers to an embedding vector of each feature, and a term on another layer refers to a term constructed by the layer constructor) on a layer, feature crossing between two terms is calculated by using the feature crossing function. The feature crossing function provided in this embodiment of this disclosure includes the following four types:
a: Naive Hadamard product (N-HP): A Hadamard product between two terms is directly calculated.

As shown in FIG. 7A, in this embodiment of this disclosure, a calculation process of the naive Hadamard product may be converted into mapping of two terms (a term A and a term B) by using an N-HP matrix.
b: Field pair-wise weight scaled Hadamard product (W-HP): After a Hadamard product between two terms is calculated, each element in a calculation result of the Hadamard product is multiplied by a same field pair-wise scaling weight. The field pair-wise scaling weight refers to a weight coefficient that can be learned by each pair of fields (also referred to as terms) to capture importance of the field pair.

As shown in FIG. 7B, in this embodiment of this disclosure, a calculation process of the field pair-wise weight scaled Hadamard product may be converted into mapping of two terms (a term A and a term B) by using a W-HP matrix.
c: Field pair-wise vector scaled Hadamard product (V-HP): After a Hadamard product between two terms is calculated, a calculation result of the Hadamard product is multiplied by a field pair-wise scaling vector. The field pair-wise scaling vector refers to a vector (whose dimension is K, where K indicates a dimension of the embedding vector) that can be learned by each pair of fields, and is configured for performing conversion on feature embeddings of a pair of fields during interaction.

As shown in FIG. 7C, in this embodiment of this disclosure, a calculation process of the field pair-wise vector scaled Hadamard product may be converted into mapping of two terms (a term A and a term B) by using a V-HP matrix.
d: Field pair-wise matrix projected Hadamard product (M-HP): Field pair-wise projecting matrix transformation is performed on one of two terms on which feature crossing is performed, and then a Hadamard product between the transformed term and the other term is calculated. The field pair-wise projecting matrix refers to a matrix (whose dimension is K*K, where K indicates a dimension of the embedding vector) that can be learned by each pair of fields, and is configured for performing conversion on feature embeddings of a pair of fields during interaction.

As shown in FIG. 7D, in this embodiment of this disclosure, a calculation process of the field pair-wise matrix projected Hadamard product may be converted into mapping of two terms (a term A and a term B) by using an M-HP matrix.

(2) Layer constructor: A cross term in a next layer is constructed by using a cross term (to be specific, a term processed by the feature crossing function) in a previous layer and feature embeddings of the first layer. The layer constructor provided in this embodiment of this disclosure includes the following:
a: Feature field-based layer constructor (Layer Assembler with Field-wise Terms, AFT): An i^{th} layer includes K terms in total (where K is equal to a quantity of fields). A k^{th} term in the i^{th} layer is equal to a calculation result of summation after feature crossing is performed on an embedding of a k^{th} field in the first layer and each term in an (i−1)^{th} layer. That is, the k^{th} term includes all i^{th}-order cross terms related to the k^{th} field.

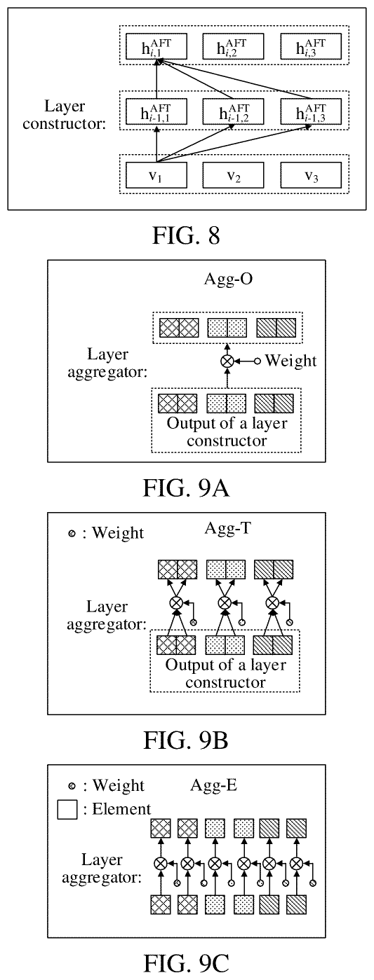

As shown in FIG. 8, when an i^{th} layer includes a total of three terms: v₁, v₂, and v₃, the first term in the i^{th} layer is equal to a calculation result of summation after feature crossing is performed on an embedding of the first field in the first layer and each term in an (i−1)^{th} layer.

(3) Layer aggregator: The layer aggregator uses embedding vectors outputted by all layer constructors as an input, aggregates the embedding vectors outputted by all the layer constructors into one representation, and uses the representation as an input of a classifier. The layer aggregator provided in this embodiment of this disclosure includes the following three types:
a: Layer aggregator with order-wise weight (Agg-O): Embedding vectors outputted by all the layer constructors are separately multiplied by a weight associated with an order, and then concatenating is performed, to obtain a representation.

As shown in FIG. 9A, the layer aggregator with order-wise weight in this embodiment of this disclosure separately multiplies embedding vectors outputted by the layer constructors by a weight associated with an order.
b: Layer aggregator with term-wise weight (Agg-T): Each term in embedding vectors outputted by all the layer constructors is multiplied by a weight associated with the term, and then concatenating is performed, to obtain a representation.

As shown in FIG. 9B, the layer aggregator with term-wise weight in this embodiment of this disclosure multiplies each term in embedding vectors outputted by the layer constructors by a weight associated with the term.
c: Layer aggregator with element-wise weight (Agg-E): Each element in embedding vectors outputted by all the layer constructors is multiplied by a weight associated with the element, and then concatenating is performed, to obtain a representation.

As shown in FIG. 9C, in this embodiment of this disclosure, the layer aggregator with element-wise weight multiplies each element in the embedding vectors outputted by the layer constructors by a weight associated with the element.

Finally, the CTR model constructs a multi-layer fully-connected deep neural network as a classifier, and uses the representation outputted by the layer aggregator as an input of the classifier. The classifier obtains, by using a normalized exponential function (softmax), a pre-estimated CTR value of the user for an advertisement.

The model provided in this embodiment of this disclosure is an end-to-end model, and all parameters of the model can be updated by using a gradient algorithm. Therefore, the method provided in this embodiment of this disclosure is applicable to any deep learning algorithm framework.

In an example of online application, a new model is trained every hour and pushed online for online prediction. A specific online prediction procedure is as follows: In operation 1, a requester sends an advertisement request, and a recall and rough sorting model preliminarily screens advertisements, and then sends an advertisement set to a fine sorting system. In operation 2, the fine sorting system queries for a user side feature and an advertisement side feature, inputs the user side feature and the advertisement side feature after preprocessing into a network structure shown in FIG. 6, and calculates a pre-estimated CTR value (pCTR)/a pre-estimated CVR value (pCVR). In operation 3, effective cost per mille (eCPM) is calculated by using the pCTR/pCVR calculated in operation 2, all advertisements in the advertisement set are sorted, and top K advertisements are selected for exposure.

To verify the effect of this solution, in this embodiment of this disclosure, some offline experiments are performed on two public data sets: Criteo and Avazu, and a synthetic data set, as shown in Table 1.

TABLE 1

| | Representative | Criteo | | | Avazu | | |
|---|---|---|---|---|---|---|---|
| Model | structures | L | AUC | Logloss | L | AUC | Logloss |
| FNO | AFT, N-HP, | 4 | 0.8082 (5e−4) | 0.4434 (6e−4) | 5 | 0.7777 (3e−4) | 0.3808 (5e−4) |
| | and Agg-O | | | | | | |
| FWO | AFT, W-HP, | 4 | 0.8124 (2e−4) | 0.4394 (2e−4) | 5 | 0.7891 (3e−4) | 0.3746 (5e−4) |
| | and Agg-O | | | | | | |
| FVO | AFT, V-HP, | 4 | 0.8123 (1e−4) | 0.4395 (2e−4) | 5 | 0.7903 (9e−4) | 0.3740 (7e−4) |
| | and Agg-O | | | | | | |
| FMO | AFT, M-HP, | 4 | 0.8138 (3e−4) | 0.8138 (3e−4) | 5 | 0.7916 (4e−4) | 0.3731 (4e−4) |
| | and Agg-O | | | | | | |
| FMT | AFT, M-HP, | 4 | 0.8138 (3e−4) | 0.8138 (3e−4) | 5 | 0.7904 (4e−4) | 0.3738 (6e−4) |
| | and Agg-T | | | | | | |
| FME | AFT, M-HP, | 4 | 0.8138 (3e−4) | 0.8138 (3e−4) | 5 | 0.7907 (2e−4) | 0.3735 (3e−4) |
| | and Agg-E | | | | | | |
| FMN | AFT, M-HP, | 4 | 0.8131 (4e−4) | 0.8131 (4e−4) | 5 | 0.7912 (5e−4) | 0.3732 (4e−4) |
| | and Agg-N | | | | | | |

It may be learned from Table 1 that, an area (AUC) formed by an ROC curve and a coordinate axis under the ROC curve on the two public data sets and a logarithm function (Logloss) prove that the model provided in this embodiment of this disclosure achieves an extremely good effect. When the crossing function and the layer constructor are kept the same, different layer aggregators achieve similar effects, and a layer aggregator with order-wise weight is relatively good.

In this embodiment of this disclosure, weights and feature crossing strengths learned by different feature crossing functions drawn on an Avazu data set are compared with mutual information between field pairs, to find that as complexity of the feature crossing function increases and a quantity of learnable parameters increases, the learned weights and feature crossing strengths are closer to the mutual information.

In this embodiment of this disclosure, synthetic data sets whose data orders (L) are equal to 4 and 5 are separately generated, and sensitivities of the model provided in this embodiment of this disclosure to model orders are compared. It is found that when a model order gradually increases and is greater than a data order, a root mean square error (RMSE) of the model provided in this embodiment of this disclosure still keeps extremely stable, proving that the layer aggregator with order-wise weight can capture importance of the data order.

The information recommendation method provided in embodiments of this disclosure has been described with reference to the exemplary application and implementation of the electronic device provided in embodiments of this disclosure. The following continues to describe that modules in an information recommendation apparatus 555 provided in embodiments of this disclosure cooperate to implement the information recommendation solution.

An obtaining module 5551 is configured to obtain a plurality of field features of a to-be-recommended task, the plurality of field features including at least one item feature of to-be-recommended information and at least one object feature of a target object. A layer construction module 5552 is configured to perform layer construction processing on the plurality of field features by using each layer constructor of a multi-layer constructor, to obtain cross features of each layer constructor. An aggregation module 5553 is configured to perform weighted aggregation processing on cross features corresponding to the multi-layer constructor, to obtain an aggregated feature of the to-be-recommended task. A prediction module 5554 is configured to perform indicator prediction (or metric prediction) processing on the aggregated feature of the to-be-recommended task, to obtain a recommendation indicator that corresponds to the target object and that is of the to-be-recommended information. A recommendation module 5555 is configured to perform a recommendation operation based on the recommendation indicator that corresponds to the target object and that is of the to-be-recommended information.

In some embodiments, the layer construction module 5552 is further configured to perform the following processing by using an i^{th}-level layer constructor of the multi-layer constructor: determining cross features of an (i−1)^{th}-level layer constructor, when the (i−1)^{th}-level layer constructor is the first-level layer constructor, the cross features of the (i−1)^{th}-level layer constructor being the plurality of field features; and performing feature crossing processing on the plurality of field features and the cross features of the (i−1)^{th}-level layer constructor, to obtain cross features of the i^{th}-level layer constructor, i being a sequentially ascending positive integer, 1<i≤I, and I being a quantity of layers of the multi-layer constructor. Note that the operation may be performed in an iteration (such as by using a for loop), as described earlier.

In some embodiments, the layer construction module 5552 is further configured to perform the following processing on a j^{th} field feature of the plurality of field features: performing feature crossing processing on the j^{th} field feature and each cross feature of the (i−1)^{th}-level layer constructor, to obtain a plurality of cross sub-features; and determining a sum of the plurality of cross sub-features as a j^{th} cross feature of the i^{th}-level layer constructor, j being a positive integer, 1≤j≤J, and J being a quantity of the plurality of field features.

In some embodiments, the layer construction module 5552 is further configured to perform the following processing on a k^{th} cross feature of the cross features of the (i−1)^{th}-level layer constructor: performing Hadamard product processing on the j^{th} field feature and the k^{th} cross feature, to obtain a k^{th} cross sub-feature, k being a positive integer, and 1≤k≤J.

In some embodiments, the layer construction module 5552 is further configured to perform the following processing on a k^{th} cross feature of the cross features of the (i−1)^{th}-level layer constructor: performing Hadamard product processing on the j^{th} field feature and the k^{th} cross feature, to obtain a k^{th} Hadamard product result; and performing mapping processing on the k^{th} Hadamard product result to obtain a k^{th} cross sub-feature, k being a positive integer, and 1≤k≤J.

In some embodiments, the layer construction module 5552 is further configured to determine a field pair-wise scaling weight corresponding to each element in the k^{th} Hadamard product result; and performing weighting processing on each element in the k^{th} Hadamard product result based on the field pair-wise scaling weight, to obtain the k^{th} cross sub-feature.

In some embodiments, the layer construction module 5552 is further configured to determine a field pair-wise scaling vector corresponding to the k^{th} Hadamard product result; and determining a product of the field pair-wise scaling vector and the k^{th} Hadamard product result as the k^{th} cross sub-feature.

In some embodiments, the layer construction module 5552 is further configured to perform the following processing on a k^{th} cross feature of the cross features of the (i−1)^{th}-level layer constructor: determining a field pair-wise projecting matrix corresponding to the j^{th} field feature; performing matrix transformation processing on the j^{th} field feature based on the field pair-wise projecting matrix, to obtain a transformed j^{th} field feature; and performing Hadamard product processing on the transformed j^{th} field feature and the k^{th} cross feature, to obtain a k^{th} cross sub-feature, k being a positive integer, and 1≤k≤J.

In some embodiments, the aggregation module 5553 is further configured to: determine a layer weight of each layer constructor; perform, based on the layer weight of each layer constructor, weighting processing on the cross features corresponding to the multi-layer constructor, to obtain weighted cross features corresponding to the multi-layer constructor; and perform concatenating processing on the weighted cross features corresponding to the multi-layer constructor, to obtain the aggregated feature of the to-be-recommended task.

In some embodiments, the aggregation module 5553 is further configured to: determine a term weight of each cross feature of each layer constructor; perform weighting processing on each cross feature of each layer constructor based on the term weight of each cross feature of each layer constructor, to obtain weighted cross features of each layer constructor; and perform concatenating processing on weighted cross features corresponding to the multi-layer constructor, to obtain the aggregated feature of the to-be-recommended task.

In some embodiments, the aggregation module 5553 is further configured to: determine an element weight of each element in each cross feature of each layer constructor; perform weighting processing on each element in each cross feature of each layer constructor based on the element weight of each element in each cross feature of each layer constructor, to obtain weighted cross features of each layer constructor; and perform concatenating processing on weighted cross features corresponding to the multi-layer constructor, to obtain the aggregated feature of the to-be-recommended task.

An embodiment of this disclosure provides a computer program product. The computer program product includes a computer program or computer-executable instructions, and the computer program or the computer-executable instructions are stored in a computer-readable storage medium. A processor of an electronic device reads the computer program or the computer-executable instructions from the computer-readable storage medium, and the processor executes the computer program or the computer-executable instructions, to enable the electronic device to perform the foregoing information recommendation method in embodiments of this disclosure.

An embodiment of this disclosure provides a computer-readable storage medium storing computer-executable instructions. The computer-readable storage medium has the computer-executable instructions or a computer program stored herein. When the computer-executable instructions or the computer program is executed by a processor, the processor performs the information recommendation method provided in embodiments of this disclosure, for example, the information recommendation method shown in FIG. 3A.

In some embodiments, the computer-readable storage medium may be a memory like a ferroelectric a random-access memory (FRAM), a ROM, a programmable read-only memory (PROM), an erasable programmable read-only memory (EPROM), an electrically erasable programmable read-only memory (EEPROM), a flash memory, a magnetic surface memory, an optical disc, or a compact disc read-only memory (CD-ROM); or may be various devices including one or any combination of the foregoing memories.

In this disclosure, a unit and a module may be hardware such as a combination of electronic circuitries; firmware; or software such as computer instructions. The unit and the module may also be any combination of hardware, firmware, and software. In some implementation, a unit may include at least one module. Each unit or module can be implemented using one or more processors (or processors and memory). Likewise, a processor (or processors and memory) can be used to implement one or more units or modules. Moreover, each unit or module can be part of an overall unit or module that includes the functionalities of the unit or module

In some embodiments, the computer-executable instructions may be in a form of a program, software, a software module, a script, or code, written in any form of programming language (including compiled or interpreted languages, or declarative or procedural languages), and may be deployed in any form, including being deployed as an independent program or being deployed as a module, a component, a subroutine, or another unit suitable for being used in a computing environment.

For example, the computer-executable instructions may but not necessarily correspond to a file in a file system, and may be stored in a part of a file that stores other programs or data, for example, stored in one or more scripts in a hyper-text markup language (HTML) document, stored in a single file dedicated to a program in question, or stored in a plurality of cooperative files (for example, files that store one or more modules, subprograms, or code parts).

For example, the computer-executable instructions may be deployed to be executed on one electronic device, to be executed on a plurality of electronic devices located at one site, or to be executed on a plurality of electronic devices distributed at a plurality of sites and interconnected by using a communication network. The foregoing descriptions are merely embodiments of this disclosure, but are not intended to limit the protection scope of this application. Any modification, equivalent replacement, or improvement made within the spirit and principle of this application shall fall within the protection scope of this application.

What is claimed is:

1. A method for information recommendation, applied to an electronic device, the method comprising:
obtaining a plurality of field features of a to-be-recommended task, the plurality of field features comprising at least one item feature of to-be-recommended information and at least one object feature of a target object;
performing layer construction processing on the plurality of field features by using each layer constructor of a multi-layer constructor, to obtain cross features of each layer constructor;
performing weighted aggregation processing on cross features corresponding to the each layer constructor of the multi-layer constructor, to obtain an aggregated feature of the to-be-recommended task;
performing metric prediction on the aggregated feature of the to-be-recommended task, to obtain a recommendation metric of the to-be-recommended information with respect to the target object; and
performing a recommendation operation based on the recommendation metric of the to-be-recommended information for the target object.

2. The method according to claim 1, wherein performing the layer construction processing on the plurality of field features comprises performing following processing by using an i^{th}-level layer constructor of the multi-layer constructor:
determining cross features of an (i−1)^{th}-level layer constructor of the multi-layer constructor, wherein when the (i−1)^{th}-level layer constructor is a first-level layer constructor, the cross features of the (i−1)^{th}-level layer constructor being the plurality of field features; and
performing feature crossing processing on the plurality of field features and the cross features of the (i−1)^{th}-level layer constructor, to obtain cross features of the i^{th}-level layer constructor;
i being a sequentially ascending positive integer, 1<i≤I, and I being an integer representing a quantity of layers of the multi-layer constructor.

3. The method according to claim 2, wherein performing feature crossing processing on the plurality of field features and the cross features of the (i−1)^{th}-level layer constructor, to obtain the cross features of the i^{th}-level layer constructor comprises performing following processing on a j^{th} field feature of the plurality of field features:
performing feature crossing processing on the j^{th} field feature and each cross feature of the (i−1)^{th}-level layer constructor, to obtain a plurality of cross sub-features; and
determining a sum of the plurality of cross sub-features as a j^{th} cross feature of the i^{th}-level layer constructor;
j being a positive integer, 1≤j≤J, and J being an integer representing a quantity of the plurality of field features.

4. The method according to claim 3, wherein performing feature crossing processing on the j^{th} field feature and each cross feature of the (i−1)^{th}-level layer constructor, to obtain the plurality of cross sub-features comprises performing following processing on a k^{th} cross feature of the cross features of the (i−1)^{th}-level layer constructor:
performing Hadamard product processing on the j^{th} field feature and the k^{th} cross feature, to obtain a k^{th} cross sub-feature;
k being a positive integer, and 1≤k≤J.

5. The method according to claim 3, wherein performing feature crossing processing on the j^{th} field feature and each cross feature of the (i−1)^{th}-level layer constructor, to obtain the plurality of cross sub-features comprises performing following processing on a k^{th} cross feature of the cross features of the (i−1)^{th}-level layer constructor:
performing Hadamard product processing on the j^{th} field feature and the k^{th} cross feature, to obtain a k^{th} Hadamard product result; and
performing mapping processing on the k^{th} Hadamard product result to obtain a k^{th} cross sub-feature;
k being a positive integer, and 1≤k≤J.

6. The method according to claim 5, wherein performing the mapping processing on the k^{th} Hadamard product result to obtain the k^{th} cross sub-feature comprises:
determining, for each element in the k-th Hadamard-product result, a field pair-wise scaling weight; and
performing weighting processing on each element in the k^{th} Hadamard product result based on the field pair-wise scaling weight, to obtain the k^{th} cross sub-feature.

7. The method according to claim 5, wherein performing the mapping processing on the k^{th} Hadamard product result to obtain a k^{th} cross sub-feature comprises:
determining a field pair-wise scaling vector corresponding to the k^{th} Hadamard product result; and
determining a product of the field pair-wise scaling vector and the k^{th} Hadamard product result as the k^{th} cross sub-feature.

8. The method according to claim 3, wherein performing the feature crossing processing on the j^{th} field feature and each cross feature of the (i−1)^{th}-level layer constructor, to obtain the plurality of cross sub-features comprises performing following processing on a k^{th} cross feature of the cross features of the (i−1)^{th}-level layer constructor:
determining a field pair-wise projecting matrix corresponding to the j^{th} field feature;
performing matrix transformation processing on the j^{th} field feature based on the field pair-wise projecting matrix, to obtain a transformed j^{th} field feature; and
performing Hadamard product processing on the transformed j^{th} field feature and the k^{th} cross feature, to obtain a k^{th} cross sub-feature;
k being a positive integer, and 1≤k≤J.

9. The method according to claim 1, wherein performing weighted aggregation processing on cross features corresponding to the multi-layer constructor, to obtain the aggregated feature of the to-be-recommended task comprises:
determining a layer weight of each layer constructor;
performing, based on the layer weight of each layer constructor, weighting processing on the cross features respectively corresponding to the multi-layer constructor, to obtain weighted cross features respectively corresponding to the multi-layer constructor; and
performing concatenating processing on the weighted cross features respectively corresponding to the multi-layer constructor, to obtain the aggregated feature of the to-be-recommended task.

10. The method according to claim 1, wherein performing weighted aggregation processing on cross features corresponding to the multi-layer constructor, to obtain the aggregated feature of the to-be-recommended task comprises:
determining a term weight for each cross feature of each layer constructor;
performing weighting processing on each cross feature of each layer constructor based on the term weight of the each cross feature of each layer constructor, to obtain weighted cross features of each layer constructor; and
performing concatenating processing on the weighted cross features respectively corresponding to the multi-layer constructor, to obtain the aggregated feature of the to-be-recommended task.

11. The method according to claim 1, wherein performing weighted aggregation processing on cross features corresponding to the multi-layer constructor, to obtain the aggregated feature of the to-be-recommended task comprises:
determining an element weight of each element in each cross feature of each layer constructor;
performing weighting processing on each element in each cross feature of each layer constructor based on the element weight of each element in each cross feature of each layer constructor, to obtain the weighted cross features of each layer constructor; and
performing concatenating processing on the weighted cross features respectively corresponding to the multi-layer constructor, to obtain the aggregated feature of the to-be-recommended task.

12. A device comprising a memory for storing computer instructions and a processor in communication with the memory, wherein, when the processor executes the computer instructions, the processor is configured to cause the device to:
obtain a plurality of field features of a to-be-recommended task, the plurality of field features comprising at least one item feature of to-be-recommended information and at least one object feature of a target object;
perform layer construction processing on the plurality of field features by using each layer constructor of a multi-layer constructor, to obtain cross features of each layer constructor;
perform weighted aggregation processing on cross features corresponding to the each layer constructor of the multi-layer constructor, to obtain an aggregated feature of the to-be-recommended task;
perform metric prediction on the aggregated feature of the to-be-recommended task, to obtain a recommendation metric of the to-be-recommended information with respect to the target object; and
perform a recommendation operation based on the recommendation metric of the to-be-recommended information for the target object.

13. The device according to claim 12, wherein, when the processor is configured to cause the device to perform the layer construction processing on the plurality of field features, the processor is configured to cause the device to perform following processing by using an i^{th}-level layer constructor of the multi-layer constructor:
determining cross features of an (i−1)^{th}-level layer constructor of the multi-layer constructor, wherein when the (i−1)^{th}-level layer constructor is a first-level layer constructor, the cross features of the (i−1)^{th}-level layer constructor being the plurality of field features; and
performing feature crossing processing on the plurality of field features and the cross features of the (i−1)^{th}-level layer constructor, to obtain cross features of the i^{th}-level layer constructor;
i being a sequentially ascending positive integer, 1<i≤I, and I being an integer representing a quantity of layers of the multi-layer constructor.

14. The device according to claim 13, wherein, when the processor is configured to cause the device to perform feature crossing processing on the plurality of field features and the cross features of the (i−1)^{th}-level layer constructor, to obtain the cross features of the i^{th}-level layer constructor, the processor is configured to cause the device to perform following processing on a j^{th} field feature of the plurality of field features:
performing feature crossing processing on the j^{th} field feature and each cross feature of the (i−1)^{th}-level layer constructor, to obtain a plurality of cross sub-features; and
determining a sum of the plurality of cross sub-features as a j^{th} cross feature of the i^{th}-level layer constructor;
j being a positive integer, 1≤j≤J, and J being an integer representing a quantity of the plurality of field features.

15. The device according to claim 14, wherein, when the processor is configured to cause the device to perform feature crossing processing on the j^{th} field feature and each cross feature of the (i−1)^{th}-level layer constructor, to obtain the plurality of cross sub-features, the processor is configured to cause the device to perform following processing on a k^{th} cross feature of the cross features of the (i−1)^{th}-level layer constructor:
performing Hadamard product processing on the j^{th} field feature and the k^{th} cross feature, to obtain a k^{th} cross sub-feature;
k being a positive integer, and 1≤k≤J.

16. The device according to claim 14, wherein, when the processor is configured to cause the device to perform feature crossing processing on the j^{th} field feature and each cross feature of the (i−1)^{th}-level layer constructor, to obtain the plurality of cross sub-features, the processor is configured to cause the device to perform following processing on a k^{th} cross feature of the cross features of the (i−1)^{th}-level layer constructor:
performing Hadamard product processing on the j^{th} field feature and the k^{th} cross feature, to obtain a k^{th} Hadamard product result; and
performing mapping processing on the k^{th} Hadamard product result to obtain a k^{th} cross sub-feature;
k being a positive integer, and 1≤k≤J.

17. The device according to claim 16, wherein, when the processor is configured to cause the device to perform the mapping processing on the k^{th} Hadamard product result to obtain the k^{th} cross sub-feature wherein, when the processor is configured to cause the device to:
determine, for each element in the k-th Hadamard-product result, a field pair-wise scaling weight; and
perform weighting processing on each element in the k^{th} Hadamard product result based on the field pair-wise scaling weight, to obtain the k^{th} cross sub-feature.

18. A non-transitory storage medium for storing computer readable instructions, the computer readable instructions, when executed by a processor, causing the processor to:
obtain a plurality of field features of a to-be-recommended task, the plurality of field features comprising at least one item feature of to-be-recommended information and at least one object feature of a target object;
perform layer construction processing on the plurality of field features by using each layer constructor of a multi-layer constructor, to obtain cross features of each layer constructor;
perform weighted aggregation processing on cross features corresponding to the each layer constructor of the multi-layer constructor, to obtain an aggregated feature of the to-be-recommended task;
perform metric prediction on the aggregated feature of the to-be-recommended task, to obtain a recommendation metric of the to-be-recommended information with respect to the target object; and
perform a recommendation operation based on the recommendation metric of the to-be-recommended information for the target object.

19. The non-transitory storage medium according to claim 18, wherein, when the computer readable instructions cause the processor to perform the layer construction processing on the plurality of field features, the computer readable instructions cause the processor to perform following processing by using an i^{th}-level layer constructor of the multi-layer constructor:
determining cross features of an (i−1)^{th}-level layer constructor of the multi-layer constructor, wherein when the (i−1)^{th}-level layer constructor is a first-level layer constructor, the cross features of the (i−1)^{th}-level layer constructor being the plurality of field features; and
performing feature crossing processing on the plurality of field features and the cross features of the (i−1)^{th}-level layer constructor, to obtain cross features of the i^{th}-level layer constructor;
i being a sequentially ascending positive integer, 1<i≤I, and I being an integer representing a quantity of layers of the multi-layer constructor.

20. The non-transitory storage medium according to claim 19, wherein, when the computer readable instructions cause the processor to perform feature crossing processing on the plurality of field features and the cross features of the (i−1)^{th}-level layer constructor, to obtain the cross features of the i^{th}-level layer constructor, the computer readable instructions cause the processor to perform following processing on a j^{th} field feature of the plurality of field features:
performing feature crossing processing on the j^{th} field feature and each cross feature of the (i−1)^{th}-level layer constructor, to obtain a plurality of cross sub-features; and
determining a sum of the plurality of cross sub-features as a j^{th} cross feature of the i^{th}-level layer constructor;
j being a positive integer, 1≤j≤J, and J being an integer representing a quantity of the plurality of field features.
